(19) United States
(12) Patent Application Publication
(10) Pub. No.: US 2005/0050647 A1
(43) Pub. Date: Mar. 10, 2005

(54) Control of laundry appliance

(75) Inventors: Toshimasa Tanaka, Seto (JP); Tsuyoshi Hosoito, Inuyama (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/964,891

(22) Filed: Oct. 15, 2004

Related U.S. Application Data
(62) Division of application No. 09/947,929, filed on Sep. 7, 2001.

(30) Foreign Application Priority Data
Sep. 11, 2000 (JP) 2000-274900

(51) Int. Cl. B08B 3/12

(52) U.S. Cl. 8/158; 68/3 R

(57) ABSTRACT

A control device for a laundry appliance storing an operation program inputs information about washing and adjusts the operation program of the laundry appliance on the basis of the input washing information.

### BACKGROUND OF THE INVENTION

1. Field of the Invention

This invention relates to control of an operation of laundry appliances such as washing machines, clothes driers, etc.

2. Description of the Related Art

Laundry appliances such as laundry washers and laundry driers have functions of detecting and setting various washing conditions including a weight, degree of soil and cloth quality of laundry, and a type of a detergent. A washing or drying operation is executed on the basis of an operation program according to the set washing conditions. As the number of the detectable or settable washing conditions is increased, the laundry can be washed more clean without being damaged, or the washing or drying operation can be executed under an optimum state.

However, since the operation program becomes complicated, the laundry appliance need to have a memory with a large capacity. Further, a large number of washing conditions require a large number of detecting mechanisms and a large number of setting operations. Additionally, even when the laundry appliance Is provided with an operation program based on various washing conditions as described above, the laundry appliance cannot cope with a new detergent developed after manufacture of the laundry appliance.

### SUMMARY OF THE INVENTION

Therefore, an object of the present invention is to provide a control device for a laundry appliance which can execute an optimum washing operation and/or drying operation according to various washing conditions, a method, system and computer program for controlling the laundry appliance, and a recording medium on which the computer program is recorded.

The present invention provides a control system for a laundry appliance storing an operation program and executing a washing or drying operation according to the operation program. The system comprises information providing means externally accessible via a communication network to transmit information about washing via the communication network and a laundry appliance control device including communication means for receiving the washing Information transmitted via the communication network from the information providing means and adjusting means for adjusting the operation program of the laundry appliance on the basis of the washing information received by the communication means.

According to the above-described system, the laundry appliance can execute optimum washing and drying operations on the basis of the washing information transmitted from the information providing means without input of washing information including cloth quality of laundry, type of detergent used and water quality.

In a preferred form, the information providing means transmits weather information via the communication network, and the adjusting means causes the laundry appliance to execute the drying operation when the adjusting means detects an indication of rainy weather on the basis of the weather information received by the communication means. In this case, the laundry appliance control device further includes storage means for storing the operation program of the laundry appliance and rewriting means for collating the operation program stored by the laundry appliance with the operation program stored by the storage means to rewrite the operation program stored by the laundry appliance depending upon a result of collation.

According to the foregoing system, the laundry appliance can execute a washing operation and a drying operation according to the washing information, such as a newly developed detergent or cloth quality, which was not supposed at the time of manufacture of the laundry appliance. Additionally, an error in the operation program stored in the laundry appliance can be monitored to be corrected.

### BRIEF DESCRIPTION OF THE DRAWINGS

Other objects, features and advantages of the present invention will become clear upon reviewing of the following description of an embodiment, made with reference to the accompanying drawings, in which:

FIG. 1 is a schematic illustration of a laundry appliance control system of an embodiment in accordance with the present invention;

FIG. 2 is a block diagram showing an electrical arrangement of the laundry appliance;

FIG. 3 is a schematic block diagram showing an electrical arrangement of a home terminal;

FIG. 4 shows a top page displayed on the home terminal;

FIG. 5 shows a page of “HOUSEWORK EXPERT” displayed on the home terminal;

FIG. 6 shows a page of “VARIOUS INFORMATION” displayed on the home terminal;

FIG. 7 shows a page of “INFORMATION ABOUT HOUSEHOLD ELECTRIC PRODUCTS” displayed on the home terminal;

FIG. 8 shows a page of “WASHING” displayed on the home terminal;

FIG. 9 shows a page of “OPERATION GUIDE” displayed on the home terminal, which page is an initial screen in the case where a “USUAL WASHING” course has been set;

FIG. 10 shows a page of “OPERATION GUIDE” displayed on the home terminal, which page displays a manner of putting laundry into the laundry appliance in the case where a “USUAL WASHING” course has been set;

FIG. 11 shows a page of “OPERATION GUIDE” displayed on the home terminal, which page displays an indication of start of the operation in the case where a “USUAL WASHING” course has been set;

FIG. 12 shows a page of “OPERATION GUIDE” displayed on the home terminal, which page displays a monitor screen under operation in the case where a “USUAL WASHING” course has been set;

FIG. 13 shows a page of “WASHING CONDITIONS” displayed on the home terminal;

FIG. 14 shows a page of “DETERGENT TYPE INPUT” displayed on the home terminal;

FIG. 15 shows a page of “WASHING CONDITIONS” displayed on the home terminal, which page displays “UNDER DATA TRANSFER”;

FIG. 16 shows a page of “HOUSEHOLD ELECTRIC APPLIANCE OPERATION MONITOR” displayed on the home terminal;

FIG. 17 shows an example of result of determination on the basis of an expected washing completion time and precipitation probability;

FIG. 18 explains drive control of household electric appliances;

FIG. 19 shows a page of “SCHEDULE SETTING” displayed on the home terminal; and

FIG. 20 is a flowchart showing a collating process for an operation program by the home terminal.

### DETAILED DESCRIPTION OF AN EMBODIMENT

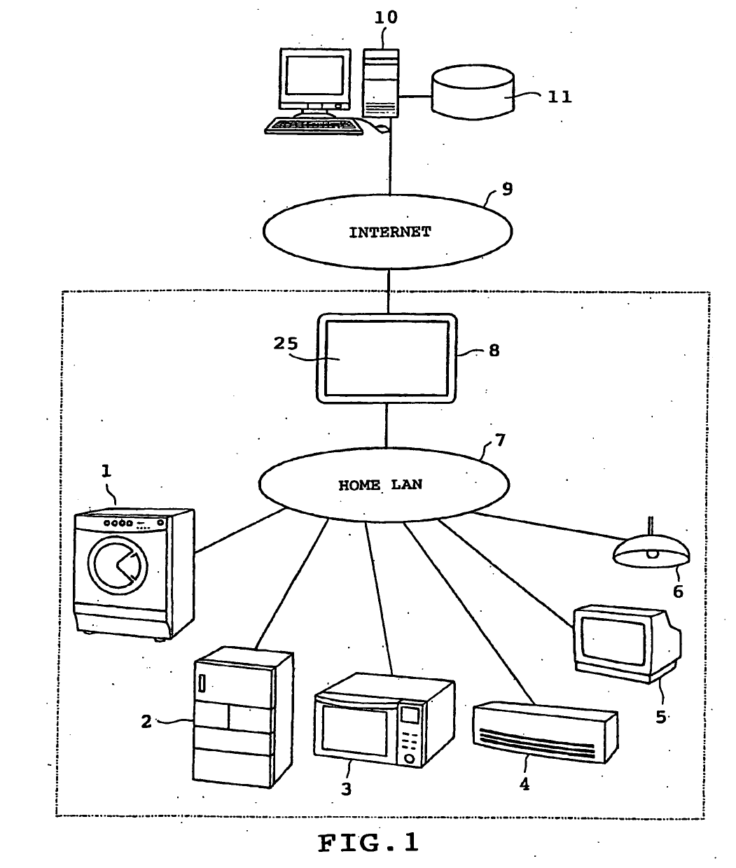

One embodiment of the present invention will be described with reference to the drawings. Referring to FIG. 1, a home electrical appliance network system is shown as including a laundry control system of the embodiment in accordance with the invention. A house is provided with an automatic washer-drier 1 serving as a laundry appliance, a refrigerator 2, a microwave oven 3, an air conditioner 4, a television set 5, and an illuminator 6. A manufacturer of the household electric appliances has a Web site on an Internet 9 by a Web server 10. The Web site is usually renewed 80 as to have latest contents. A user of the household electric appliances accesses to the Web site to get various pieces of information available in using the household electric appliances.

The Web server 10 provides information by the Web site and serves as information providing means in the invention. The Web server 10 includes communication means for communicating via the Internet 9 and a data base 11 required to operate each household electric appliance, particularly, the washer-drier 1. More specifically, the data base 11 stores washing information including weather information for each region, water quality information for each region, detergent information of each detergent maker, information provided by cloth makers and cleaning laboratories, marketing information provided by supermarkets, and an operation program of the washer-drier 1. A display, keyboard, mouse, etc. are connected to the Web server 10. Servicemen and engineers of the household electric appliance manufacturer and maintenance service company use these input and output devices to input and output various pieces of information or the operation program.

Each of the foregoing household electric appliances 1 to 6 is provided with communication means, so that the home LAN 7 can be constructed in a home when a dweller purchases one or more of the appliances. The household electric appliances 1 to 6 are connected via the home LAN 7 to the home terminal 8 serving as a laundry appliance control device in the invention. The home terminal 8 communicates via the home LAN 7 with each of the foregoing household electric appliances. The home terminal 8 further accesses via the Internet 9 to the Web server 10 and transmits and receives an electronic mail. The home LAN 7 is constructed by the wireless communication by means of Echonet, Ethernet or Bluetooth or the infrared communication.

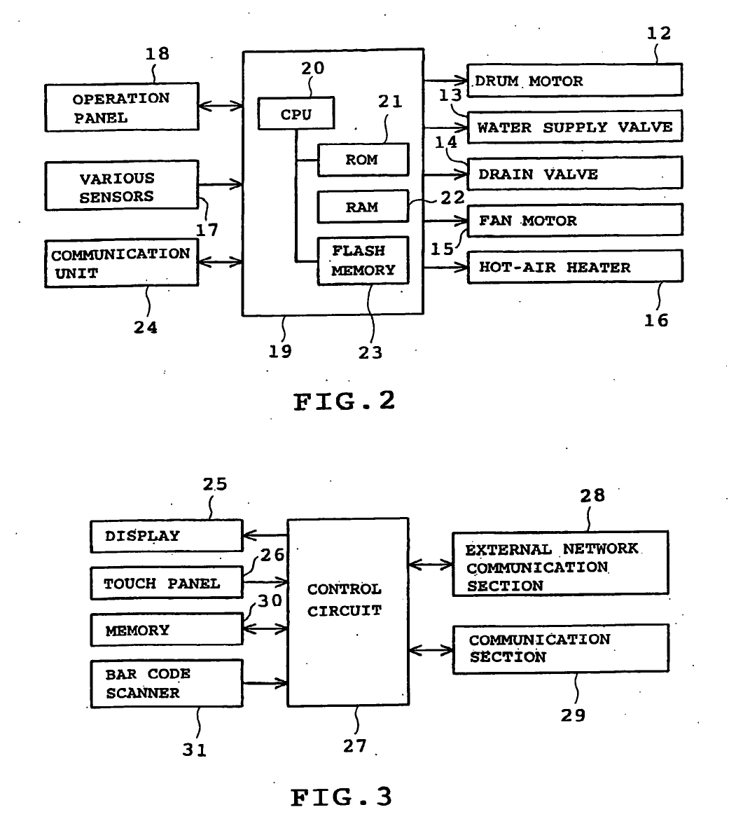

The washer-drier 1 executes a washing operation including a wash step, a rinse step and a dehydration step, and a drying operation. The washer-drier 1 comprises an outer cabinet having a laundry access opening formed in the front, a water tub disposed in the outer cabinet and a rotating drum rotatably mounted in the water tub, none of which are shown. Referring to FIG. 2, a control circuit 19 comprises a microcomputer including a CPU 20, a ROM 21, a RAM 22 and a flash memory 23 storing an operation program of the washer-drier 1.

To the control circuit 19 are connected a drum motor 12 rotating the rotating drum, a water supply valve 13 constituting a water supply mechanism, a drain valve 14 constituting a drain mechanism, and a fan motor 15 and a hot-air heater 16 both constituting a drying mechanism. Furthermore, output signals are supplied to the control circuit 19 from various sensors 17 including a water level sensor detecting a water level in the water tub and a temperature sensor detecting a temperature of washing water, and a soil sensor detecting a soil degree of laundry. An operation signal is further supplied from an operation panel 18 to the control circuit 19. Based on the operation of the operation panel 18 by the user and detection by the sensors, the control circuit 19 controls various mechanisms according to the operation program stored on the flash memory 23. Additionally, a communication unit 24 is further connected to the control circuit 19. Data the home terminal 8 transmits via the home LAN 9 is supplied via the communication unit 24 to the control circuit 19. The home terminal 8 is generally formed into the shape of a thin rectangular panel and includes a full-color liquid crystal display 25 provided on the overall front thereof, as shown in FIG. 1. A touch panel 26 (see FIG. 3) is provided on the surface of the display 25. The touch panel 26 serves as washing information inputting means, schedule setting means, detergent setting means and region setting means.

Referring to FIG. 3, an electrical arrangement of the home terminal 8 is shown. The display 25 and the touch panel 26 are connected to a control circuit 27 comprising a microcomputer. The control circuit 27 serves as control means. A communication section 29 is connected via an external network communication section 28 and the home LAN 7 to the control circuit 27. The external network communication section 28 serving as communication means executes data communication with the Web server 10 via the Internet 9. The communication section 29 executes data communication with each of the electric appliances 1 to 6 via the home LAN 7. A memory 30 storing various pieces of data, the operation program, etc. and a bar code scanner 31 for reading a bar code are connected to the control circuit 27. The memory 30 serves as storage means.

The home terminal 8 is powered by a secondary battery (not shown) and detachably attached to the front of one of doors of the refrigerator 2. When attached to the refrigerator 2, the secondary battery is charged by a charging device (not shown) provided in the refrigerator 2. The home terminal 8 is operable irrespective of the charged state of the secondary battery when attached to the refrigerator 2. The home terminal 8 functions as an operation section for the setting of temperatures in the refrigerator 2 and a monitor for the temperatures in the refrigerator 2. Furthermore, the touch panel 26 is touched so that the home terminal 8 accesses to a Web site provided by the maker to receive various pieces of information and various operation programs. Based on the received washing information and operation program of the washer-drier, the home terminal 8 adjusts the contents of the operation executed by the washer-drier 1. Accordingly, the control circuit 27 and external network communication section 28 function as washing information inputting means. The control circuit 27 functions as adjusting means and rewriting means. Additionally, the home terminal 8 receives information about an operating state from each of the appliances 1 to 6, supervising and controlling electric power consumed by each appliance.

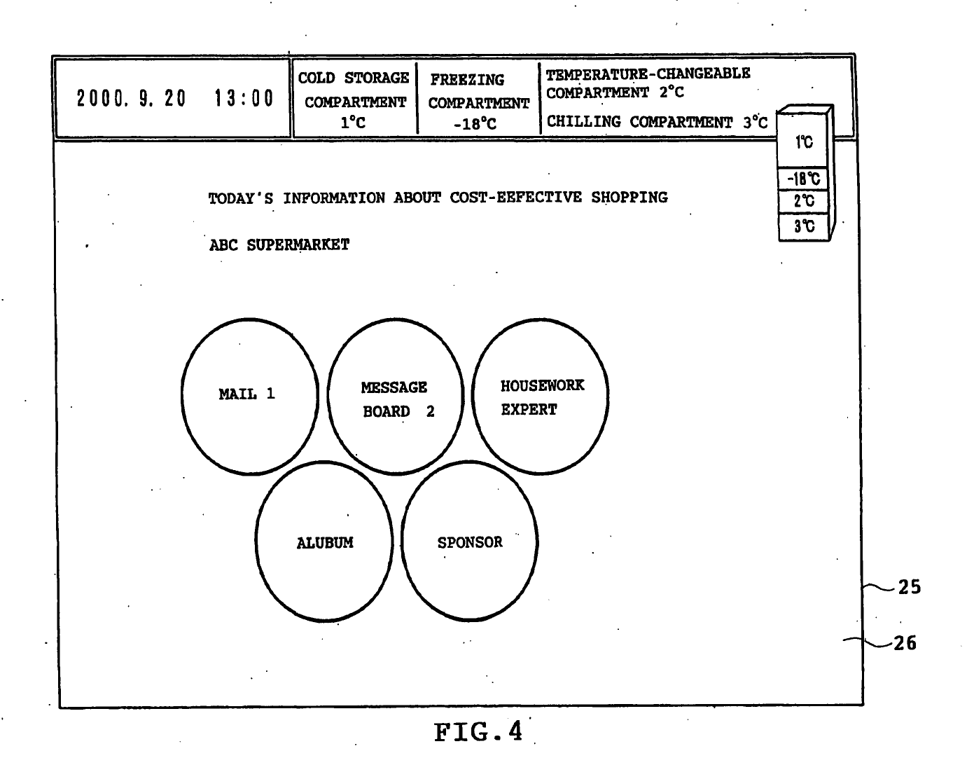

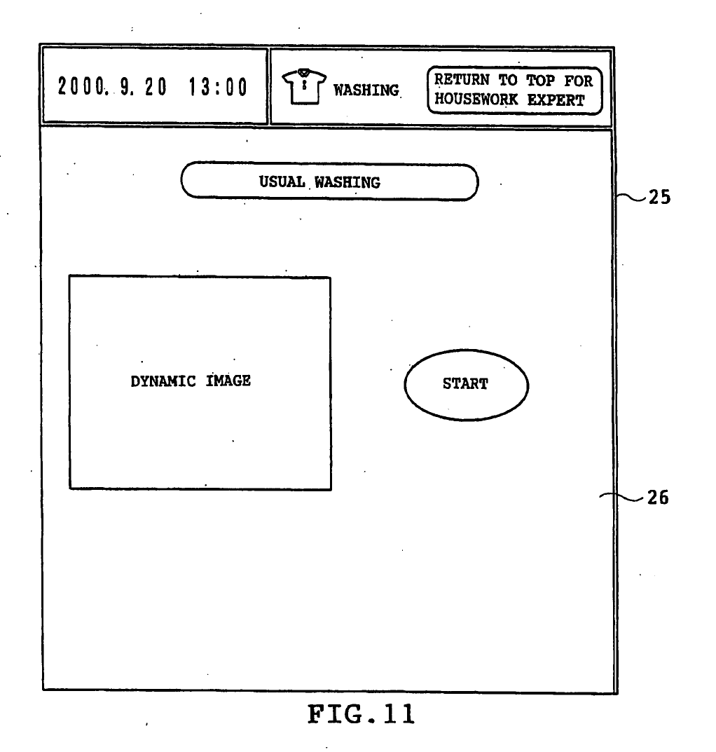

The operation of the foregoing system will now be described with reference to FIGS. 4 to 20. Firstly, functions of the home terminal 8 will be described with reference to FIGS. 4 to 16 and 19. The display 25 of the home terminal 8 normally displays a top page as shown in FIG. 4. Menus of “MAIL,” “MESSAGE BOARD,” “HOUSEWORK EXPERT,” “ALBUM” and “SPONSOR” are set on the top page. The number of received electronic mails is displayed with the menu of “MAIL.” The number of recorded messages is displayed with the menu of “MESSAGE BOARD.” When each of icons of these menus is touched, each menu is processed. The menu of “ALBUM” has functions of recording, arranging and displaying images and dynamic images. The menu of “SPONSOR” has a function of providing information about advertisement. The top page displays on the top the date and current time, a temperature in a cold storage compartment, a temperature in a freezing compartment, a temperature in a temperature-changeable compartment and a temperature in a vegetable compartment (chilling in FIG. 4). Information about a supermarket input from the Web server 10 (information about discount) is displayed over the menus on the top page.

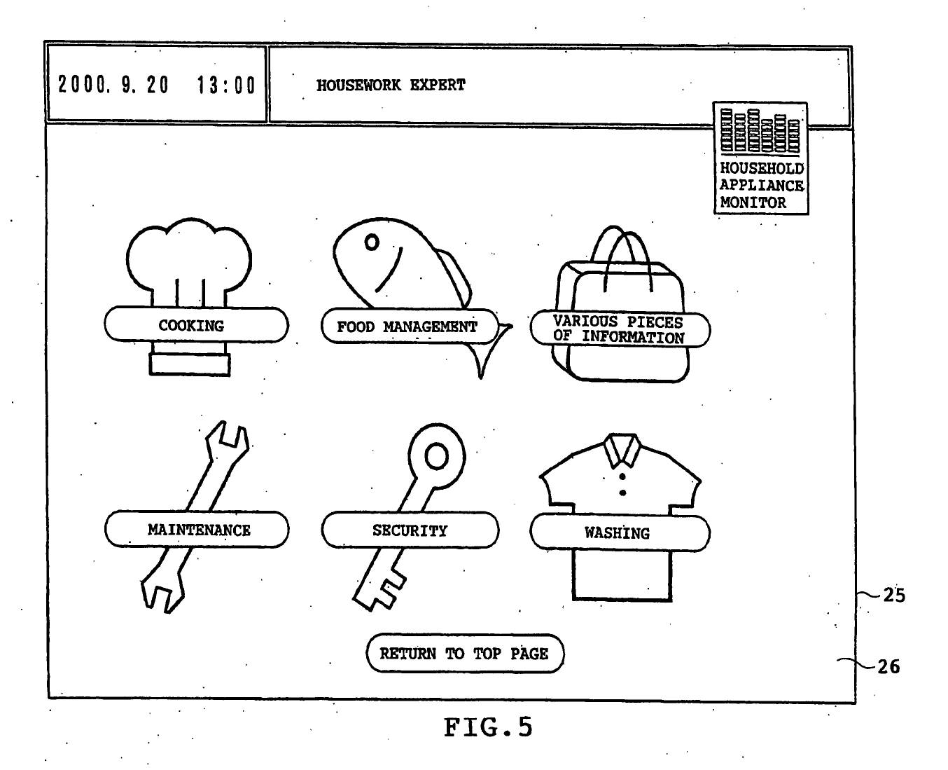

When the menu of “HOUSEWORK EXPERT” is touched on the top page, a page of “HOUSEWORK EXPERT” as shown in FIG. 5 is displayed on the display 25. This page displays menus for getting various information and services available in using the household electric appliances. The menus include “COOKING,” “FOOD MANAGEMENT,” “VARIOUS PIECES OF INFORMATION,” “MAINTENANCE,” “SECURITY” and “WASHING.” When touched, each of the menus is processed. Further, a menu of “APPLIANCE MONITOR” to confirm the operating conditions of the household electric appliances etc. is set on the right-hand upper corner of the page of “HOUSEWORK EXPERT.”

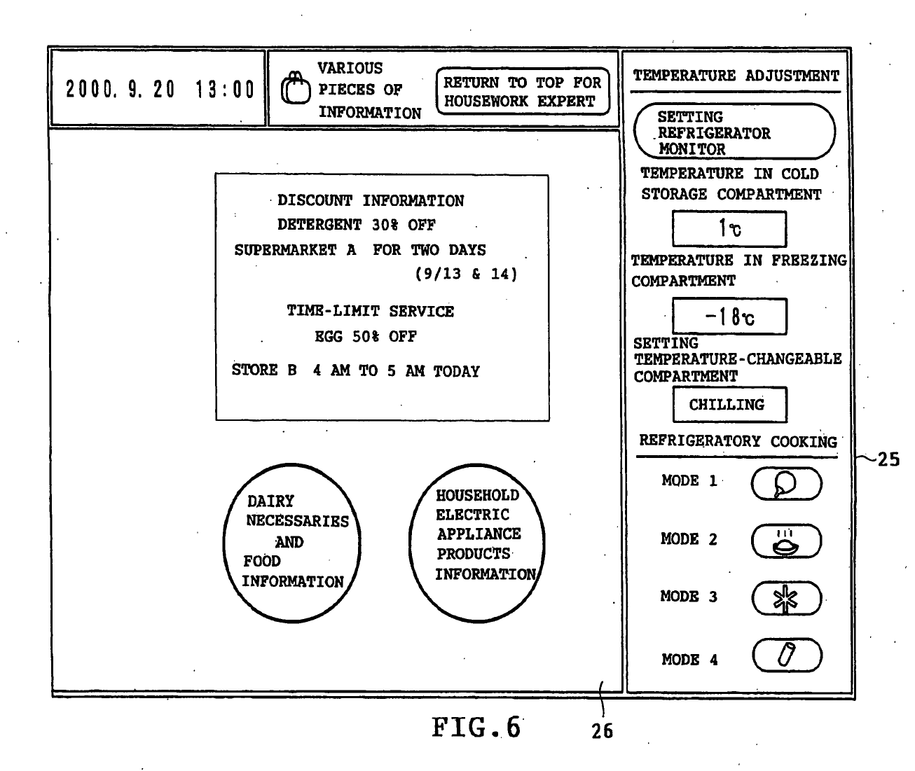

When the menu of “VARIOUS PIECES OF INFORMATION” is touched on the page of “HOUSEWORK EXPERT,” the display 25 displays a page of “VARIOUS PIECES OF INFORMATION” as shown in FIG. 6. Messages about discount in a plurality of supermarkets are displayed. Further, menus of “INFORMATION ABOUT DAILY GOODS AND FOOD” and “INFORMATION ABOUT HOUSEHOLD ELECTRIC PRODUCTS” are set. These menus relate to the mail order sale. On the right-hand corner of the page of “VARIOUS PIECES OF INFORMATION” are displayed a “REFRIGERATOR MONITOR SETTING” button and four mode setting buttons of temperature in cold storage compartment, temperature in freezing compartment, temperature in temperature-changeable compartment and refrigeratory cooking.

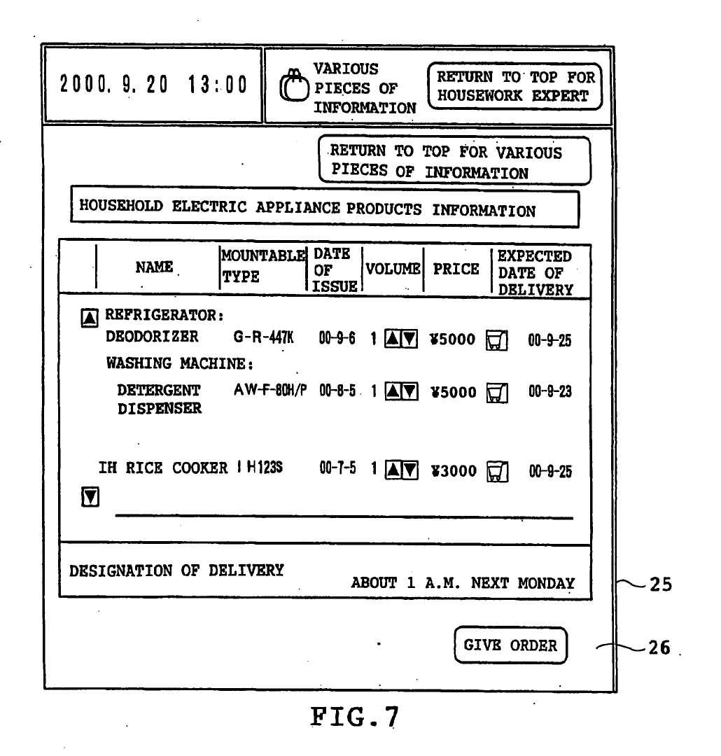

When the menu of “INFORMATION ABOUT HOUSEHOLD ELECTRIC PRODUCTS” is selected on the page of “VARIOUS PIECES OF INFORMATION,” the display 25 displays a page of “INFORMATION ABOUT HOUSEHOLD ELECTRIC PRODUCTS” as shown in FIG. 7. Information about various household electric appliances is displayed on this page, so that the user can give an order of a desired product via the Internet 9 to the Web site 10.

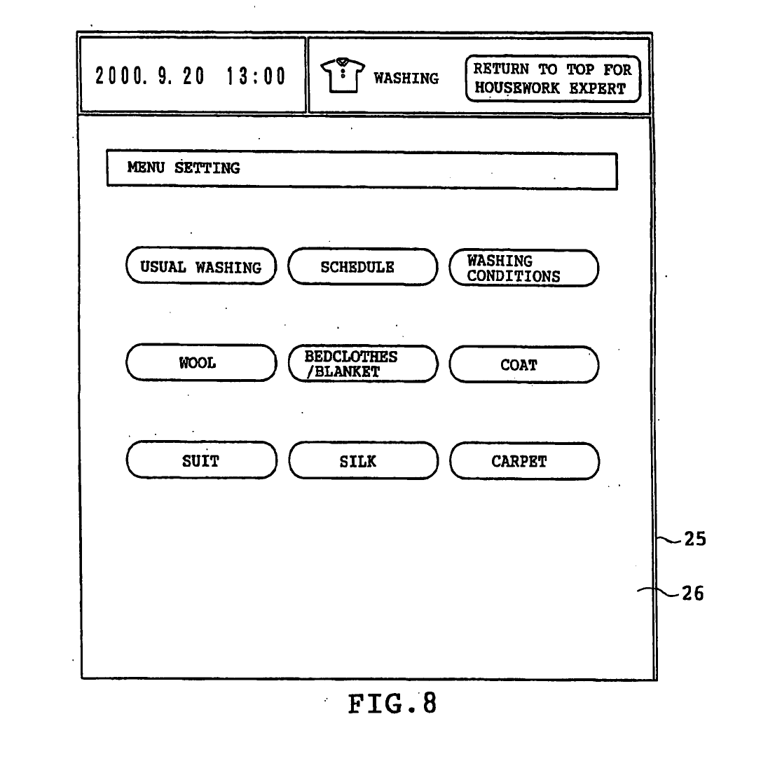

When the menu of “WASHING” is touched on the page of “HOUSEWORK EXPERT” as shown in FIG. 5, the display 25 displays a page of “WASHING” as shown in FIG. 8. Course menus for setting and executing an operation course of the washer-drier 1 are set on the page of “WASHING.” The course menus include “USUAL WASHING,” “WOOL,” “BEDCLOTHES/BLANKET,” “COAT,” “SUIT,” “SILK” and “CARPET.” A menu of “SCHEDULE” for setting a schedule of washing is also set on the page of “WASHING.” A menu of “WASHING CONDITIONS” for setting washing conditions in detail is further set on the page of “WASHING.”

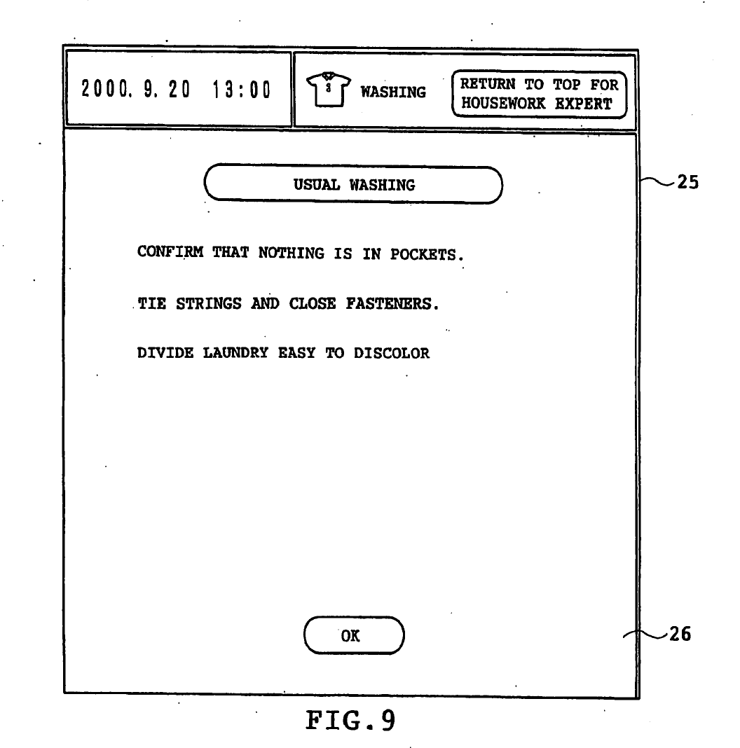

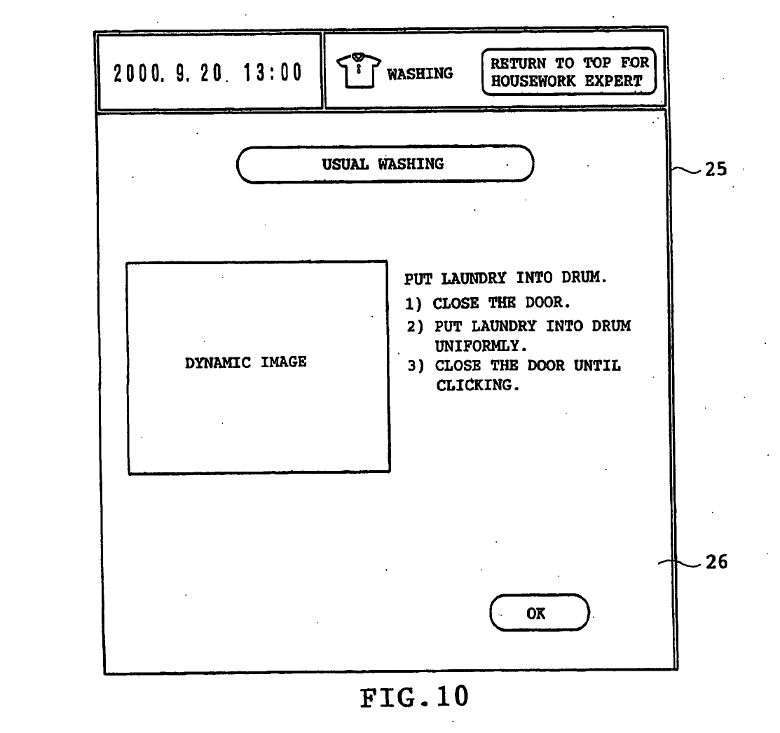

When the course menu is selected on the page of “WASHING,” the processing for the operation course is initiated. For example, when the course menu of “USUAL WASHING” is set, the display 25 displays a page of “OPERATION GUIDE” for the “USUAL WASHING” course as shown in FIG. 9. Messages are displayed on the page of “OPERATION GUIDE” to give advice to the user in the washing. When an “OK” key is touched on the page, messages indicative of a procedure for putting laundry into the washer-drier 1 are displayed as shown in FIG. 10. A dynamic image indicative of the state of the washer-drier 0.1 is also displayed. For example, the dynamic image shows the state where laundry is being put into the rotating drum of the washer-drier 1. When the “OK” key is then touched, the page of “OPERATION GUIDE” displays a “START” key and a dynamic image. When the “START” key is touched, the washer-drier 1 starts the washing operation. A monitor screen is displayed on the “OPERATION GUIDE” page.

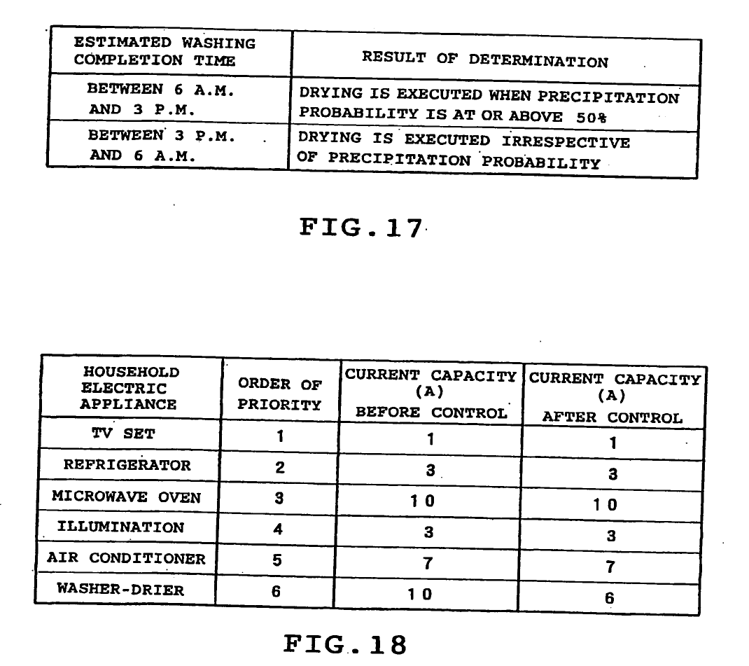

When the “USUAL WASHING” course is set, the washer-drier 1 basically executes only a washing operation including wash, rinse and dehydration steps. In this case, the hole terminal 8 determines whether the drying operation should be executed, based on an expected washing completion time (time when the dehydration step is completed) and weather information (precipitation probability) contained in the washing information received via the Internet 9 from the Web server 10. FIG. 17 shows an example of result of determination. The drying operation is executed when the expected washing completion time is between 3 p.m. and 6 a.m. In the case where the expected washing completion time is between 6 a.m. and 3 p.m., the drying operation is executed when the precipitation probability is at or above 50%.

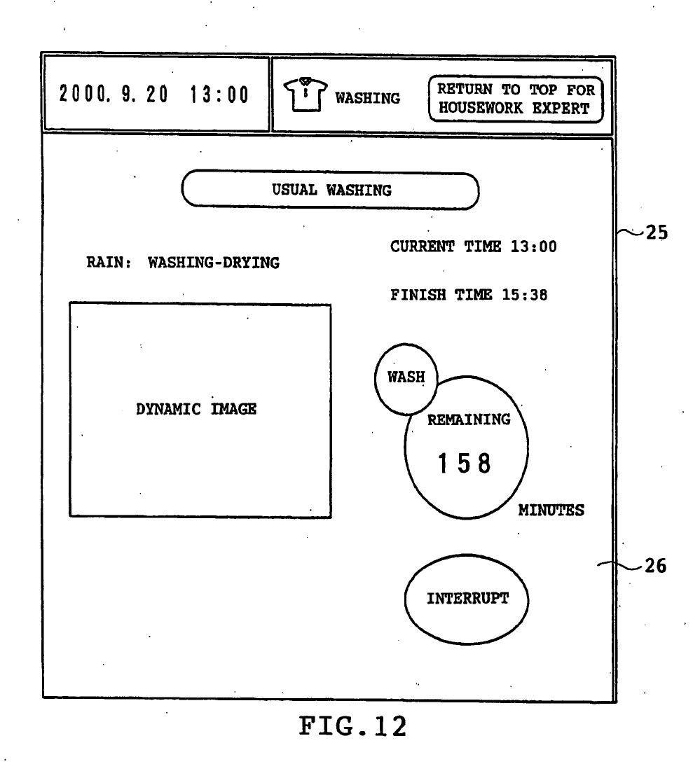

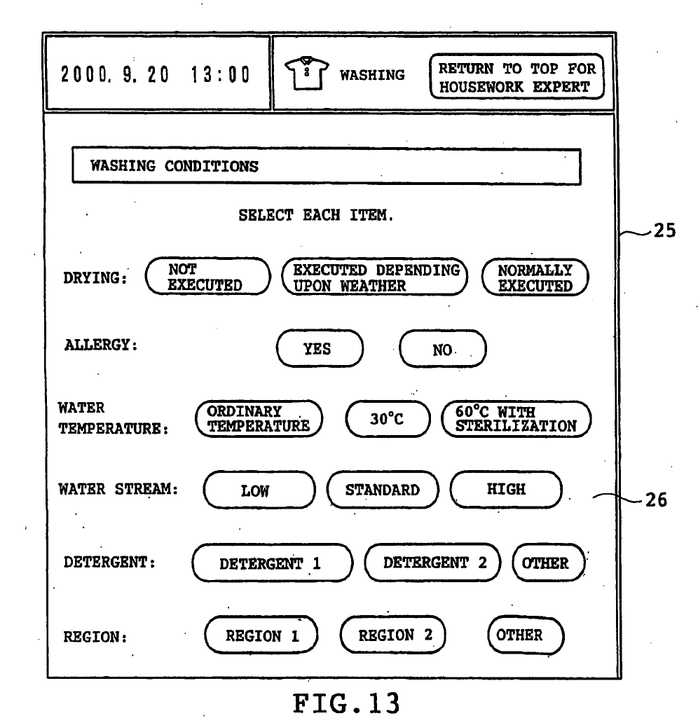

FIG. 12 shows an example of a monitor screen on the “OPERATIN GUIDE” page. On the monitor screen are displayed the current weather, the operation of the washer-drier 1 (“WASHING” in the execution of only the washing operation and “WASHING-DRYING” in the execution of the washing and drying operations), the current time, the expected washing completion time, the step under execution (the wash step in FIG. 12) and a remaining time. Furthermore, when the “WASHING CONDITION” menu is selected on the “WASHING” page, the display 25 displays a “WASHING CONDITION” page as shown in FIG. 13. “DRYING,” “ALLERGY.” “WATER TEMPERATURE,” “WATER STREAM,” “DETERGENT” and “REGION” are displayed on this page. These Items of the washing condition are optionally set by the user. The “DRYING” item includes three setting keys, “DRYING IS NOT EXECUTED,” “DRYING IS EXECUTED DEPENDING UPON WEATHER,” and “DRYING IS NORMALLY EXECUTED.” The “ALLERGY” item includes two setting keys for setting presence or absence of allergy respectively. The “WATER TEMPERATURE” item includes three setting keys for setting a temperature in the wash water among “NORMAL TEMPERATURE” (no heating by a heater), “30° C.” and “60° C. WITH STERILIZATION” (sterilization mode). The “WATER STREAM” item includes three setting keys for setting the water stream among “LOW,” “STANDARD” and “HIGH.” The “DETERGENT” item includes three setting keys for setting the type of detergent. The “REGION” item includes three keys for setting the region where the washer-drier 1 is used.

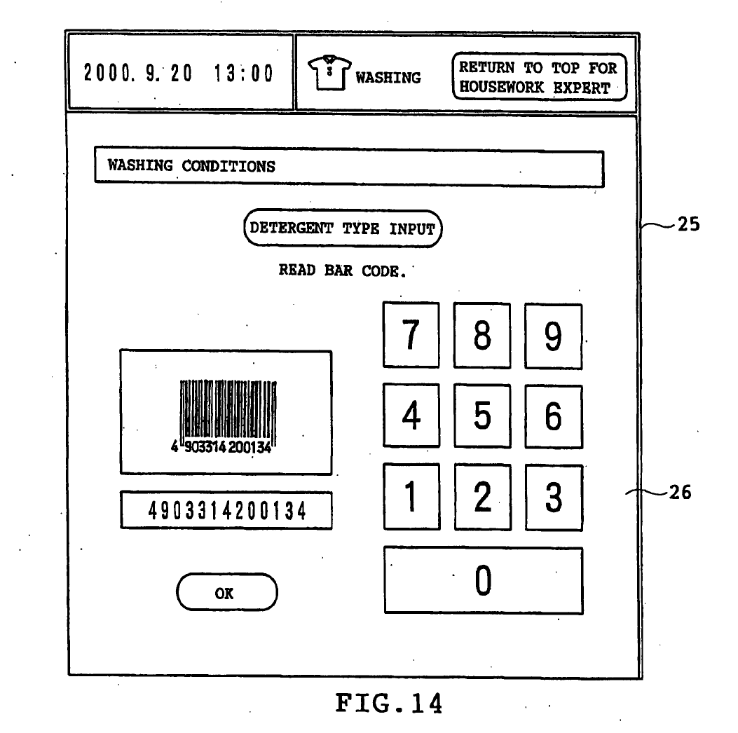

When the “OTHER” key is operated in the “DETERGENT” item, a page of “DETERGENT TYPE INPUT” as shown in FIG. 14 is displayed. The detergent type other than “DETERGENT 1” and “DETERGENT 2” is set on this page. A message indicating read of a bar code on the detergent container and numeral keys are displayed. The user reads the bar code on the detergent container by a bar code scanner 31 or inputs numerals below the bar code using the numeral keys, thereby inputting the detergent type. Thus, the washer-drier can cope with the case where a new detergent will be marketed.

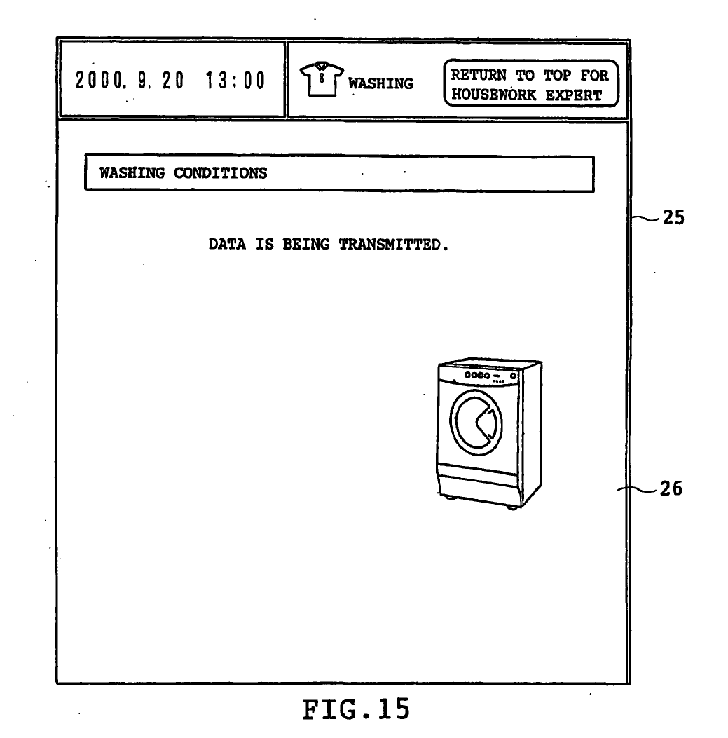

The washing conditions set on the “WASHING CONDITIONS” page are transmitted via the Internet 9 to the Web server 10. The Web server 10 determines the water quality in the region where the washer-drier 1 is used, based on the water quality information stored for every region on the data base 11. The Web server 10 then transmits to the home terminal 8 the operation program suitable for the set items such as water quality, detergent information, etc. In the transmission of the operation program, the “WASHING CONDITIONS” page displays a message indicative of “under data transmission” as shown in FIG. 15. The operation program received from the home terminal 8 is stored on the memory 30 of the home terminal 8. Thereafter, the home terminal 8 adjusts the operation program of the washer-drier 1 on the basis of the program stored on the memory 30.

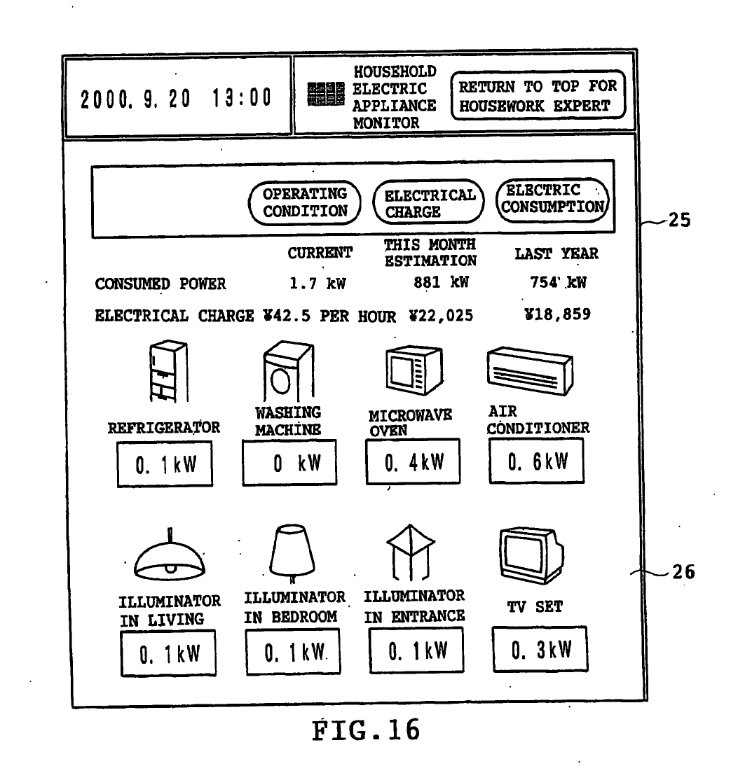

On the other hand, when the menu of “INFORMATION ABOUT HOUSEHOLD ELECTRIC PRODUCTS” is touched on the “HOUSEWORK EXPERT” in FIG. 5, the display 25 displays a page of “HOUSEHOLD ELECTRIC APPLIANCE OPERATION MONITOR” as shown in FIG. 16. In this case, the current operating condition, amount of electric power consumed, and electrical charges recognized by the home terminal 8 for each household electric appliance are displayed. More specifically, each of the appliances 1 to 6 transmits operation state information including the operating condition, drive current, etc. to the home terminal 8 at predetermined intervals (at intervals of one minute, for example). Based on the received operation state information, the home terminal 8 displays the above-mentioned page of “HOUSEHOLD ELECTRIC APPLIANCE OPERATION MONITOR” and controls each appliance so that the total current (power) consumed by all the appliances 1 to 6 does not exceed a maximum capacity.

FIG. 18 explains the contents of control of the household electric appliances 1 to 6 by the home terminal 8 provided in a house with a breaker having a capacity of 30 A (3 kW). In FIG. 18, the current consumed by the TV set is 1 A before the control. The current consumed by the refrigerator is 3 A. The current consumed by the microwave oven is 10 A. The current consumed by the illuminators is 3 A. The current consumed by the air conditioner Is 7 A. The current consumed by the washer-drier is 10 A. As a result, the total current consumed by all the appliances becomes 34 A, which value exceeds the maximum capacity. The control circuit 27 of the home terminal 8 controls the appliances so that an amount of current consumed by each appliance having the lower priority is sequentially reduced. A larger value indicates a lower priority in FIG. 18. More specifically, the output of the heater 16 in the washer-drier 1 having the lowest priority is reduced so that the consumed current decreases from 10 A to 6 A. Consequently, the total current consumed by all the appliances becomes 30 A, whereby the breaker can be prevented from sudden operation.

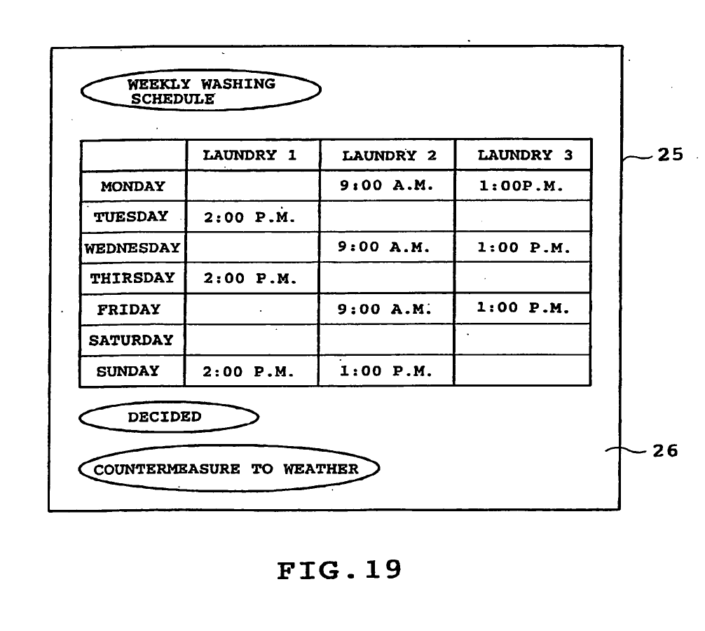

When the “SCHEDULE” menu Is touched on the “WASHING” page in FIG. 8, the display 25 displays a “SCHEDULE SETTING” page as shown in FIG. 19. On this page are provided a “SCHEDULE SETTING” key for setting a weekly washing schedule (start times of washing operation), a “CONFIRMATION” key for confirming the set washing schedule, and a “WEATHER” key for automatically changing the confirmed washing schedule according to the weather (precipitation information). The confirmed washing schedule is stored on the memory 30 of the home terminal 8. The home terminal 8 gives the alarm by display on the display 25 or buzzer when the start time of the washing operation Is reached.

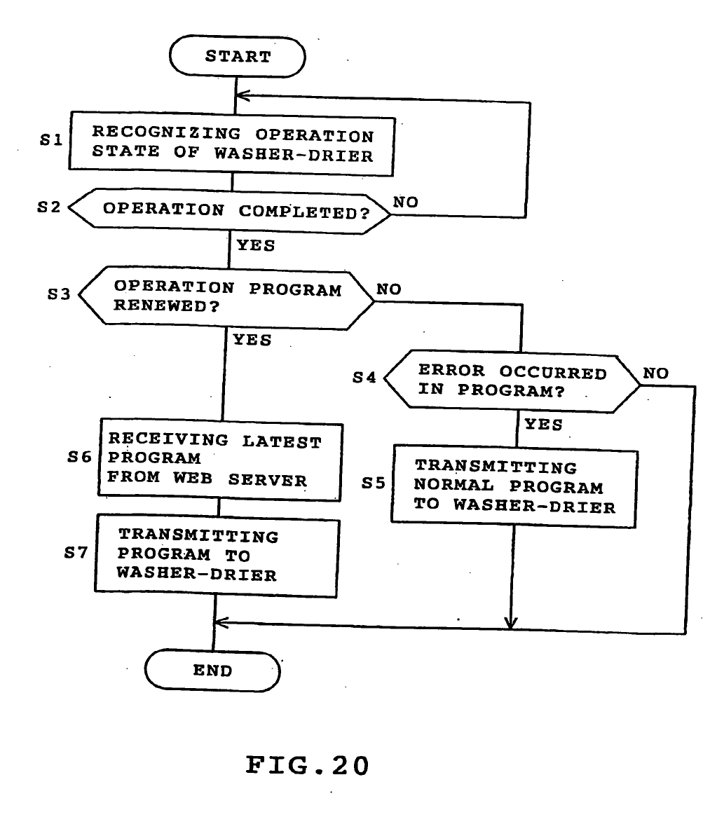

Referring now to FIG. 20, the home terminal 8 recognizes an operating state of the washer-drier 1 on the basis of the operating state information (step S1). Upon completion of the washing operation (YES at step S2), the home terminal 8 accesses to the Web server 10 to determine whether the operation program of the washer-drier 1 should be renewed (step S3). When the renewal of the operation program is unnecessary (NO at step S3), the home terminal 8 compares the operation program with the one stored on the memory 30, thereby determining whether an error has occurred in the operation program (step S4). When determining that no error has occurred in the operation program (YES at step S4), the home terminal 8 finishes the control. On the other hand, when the operation program executed by the washer-drier 1 disagrees with the operation program stored on the memory 30, for example, the home terminal 8 determines that an error has occurred in the operation program (NO at step S4). The home terminal 8 then transmits the operation program stored on the memory 30 to the washer-drier 1 (step S5). The operation program stored on the flash memory 23 of the washer-drier 1 is replaced by the one stored on the memory 30. Thus, the error occurred in the flash memory 23 of the washer-drier 1 can quickly be corrected.

The home terminal 8 determines that the operation program should be renewed (YES at step S3) when a new operation program is originated on the basis of detergent information obtained from detergent makers and washing information obtained from clothes makers and cleaning laboratories, or when the operation program is changed so as to correspond to a newly added optional component such as a detergent dispenser. When the optional component is attached to the washer-drier 1, the washer-drier transmits information about attachment of the optional component to the home terminal 8. The home terminal 8 then receives the latest operation program via the Internet 9 from the Web server 10 (step S6), transmitting the received operation program to the washer-drier 1 (step S7). As a result, the operation program stored on the flash memory 23 is replaced by the latest one.

According to the above-described embodiment, the washer-drier 1 is connected via the home LAN to the home terminal 8, which is further connected via the Internet 9 to the Web server 10. The home terminal 8 adjusts the operation of the washer-drier 1 on the basis of the washing information received from the Web server 10. Accordingly, the washer-drier 1 can automatically execute a proper washing operation according to the conditions such as the weather, type of detergent, water quality in the region, etc. In particular, although the weather changes from day to day, the user need not input the weather information every time the washing operation is executed.

Furthermore, the home terminal 8 is provided with the function of monitoring the total power consumed by the electric appliances 1 to 6 and the function of managing the set washing schedule. Consequently, the home terminal 8 can remote control or manage the household electric appliances.

The home terminal 8 may cause the display 25 to display messages when the total amount of current consumed by the appliances 1 to 6 is about to exceed the maximum capacity or reaches 29 A. When viewing the messages, the user can interrupt some electric appliances (the microwave oven 3 and air conditioner 4, for example).

The home terminal 8 may cause the washer-drier 1 to start the washing operation when the start time is reached on the basis of the set washing schedule. Furthermore, the display 25 may display a message urging the user to change the washing schedule on the basis of the weather. The home terminal 8 may set a schedule for the overall housework, instead of the washing schedule. Additionally, the present invention may be applied to automatic washing machines, driers and a combination of the automatic washing machine and drier.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

1. A control device for a laundry appliance storing an operation program, comprising:
washing information inputting means for inputting information about washing;
storage means for storing information, with respect to a plurality of regions, about a washing operation suitable for water quality in a respective region;
region setting means for setting a region in which the laundry appliance is to be used; and
adjusting means for adjusting the operation program of the laundry appliance on the basis of the washing information input by the washing information inputting means and washing operation information corresponding to the set region.

2-3. (Canceled).

4. A control device according to claim 1, further comprising setting means for setting a start time of a washing operation and control means for causing the operation program of the laundry appliance to be executed on the basis of the set start time.

5-12. (Canceled).

13. A control system for a laundry appliance storing an operation program and executing a washing operation including wash, rinse, and dehydration steps or a drying operation according to the operation program, the system comprising:
an information providing device externally accessible via a communication network to transmit information about a washing operation suitable for water quality in a region; and
a laundry appliance control device including region setting means for setting a region in which the laundry appliance is to be used, communication means for receiving the washing information transmitted via the communication network from the information providing device, and adjusting means for adjusting the operation program stored by the laundry appliance on the basis of washing operation information corresponding to the region set by the region setting means.

14-17. (Canceled)
